(19) United States
(12) Patent Application Publication
(10) Pub. No.: US 2005/0079967 A1
(43) Pub. Date: Apr. 14, 2005

(54) Decoration made of tubular tapes

(76) Inventor: Kyoko Inao, Kyoto (JP)

Correspondence Address: HODGSON RUSS LLP, ONE M & T PLAZA, SUITE 2000, BUFFALO, NY, 14203-2391, US

(21) Appl. No.: 10/900,481

(22) Filed: Jul. 27, 2004

(30) Foreign Application Priority Data
Aug. 28, 2002 (JP) 2002-247,903
Mar. 18, 2004 (JP) 2004-82562

(51) Int. Cl. B31B 1/60

(52) U.S. Cl. 493/210; 493/405

(57) ABSTRACT

Decorations of various designs including dish-shaped and basket-shaped decorations can be prepared by using tubular tapes through each of which a wire is passed in its whole length, wherein a plate is formed by weaving a plurality of said tubular tapes, with one of said tubular tapes being gathered and attached to the periphery of the plate, and both end portions of each said tubular tape protruding from the gathered tape are bent alternately in opposite sides to cover said gathered tape thereby to form an edge of the plate. Also, it is possible to prepare a flower-shaped decoration, wherein a tubular tape is gathered and wound around a bar thinner than said tape and then the bar is pulled out to form a rose-shaped artificial flower having a cavity at its center with one end portion of said tape being used as a clasp.

### BACKGROUND OF THE INVENTION

The present invention relates to a decoration made of tubular tapes through each of which a wire is passed as a core.

Japanese Laid-Open Patent Publications No. 236097 of 1998, No. 110056 of 2000 and No. 180196 of 2001 disclose decorations made of tubular tapes through each of which a wire is passed.

However, it is difficult to obtain products of various designs from the tubular tapes alone by the methods disclosed in these Publications.

### SUMMARY OF THE INVENTION

An object of the present invention is to provide decorations of various designs which can be prepared from the tubular tapes alone through each of which a wire is passed as a core.

According to the present invention, decorations of various designs including dish-shaped and basket-shaped decorations are provided by weaving a plurality of tubular tapes through each of which a wire is passed in its length to form a plate, and attaching a tubular tape being wrinkled or gathered to the periphery of the plate, and bending both end portions of each said tubular tape protruding from the gathered tape alternately in opposite sides to cover said gathered tape thereby to form an edge of the plate.

The material for a tubular tape is not especially restricted but paper, particularly Japanese paper, or cloth both having printed pattern is preferably used.

The width of the tubular tape is preferably about 4 to 12 mm, more preferably 5 to 10 mm to achieve a good appearance and stability of the product.

The method for weaving the tubular tapes to form a plate may be the same as that for preparing textile fabrics, for example, plain weaving, twill weaving or satin weaving can be used. The simplest method is plain weaving. According to the present invention, various products can be obtained from even plain-woven tubular tapes.

The tubular tapes of different thicknesses can be combined. Most of them are used as they are flattened and some of them are used as they are partly gathered or partly twisted, so that it is possible to stabilize the woven tissue and enhance design effect.

According to the present invention, a decoration with high quality is provided by using a peripheral tape which is gathered on the core wire, wherein the end portions of other tubular tapes can be bent and fixed stably without slipping over the periphery tape.

The decoration of the invention has high stability because of the wire included in the whole length of the tubular tape. The wire has a thickness that cannot be perceived from outside of the tape, for example, a diameter not more than 1 mm, such as about 0.3 to 0.8 mm.

Furthermore, according to the present invention, an artificial flower which can be easily fitted onto various decorations can be easily prepared by using said tubular tape through which a wire is passed along its whole length. This artificial flower is prepared by winding a gathered tubular tape around a bar thinner than the width of the tape, for example, a bar having a thickness of about 10 to 50% of the width of the tape and then by pulling out the bar to produce a rose-shaped artificial flower having a cavity at its center with one end of said tape being used as a clasp. The central end portion (that is, the end portion at which winding starts) is preferably used as a clasp.

This artificial flower can be attached by fixing the end portion of said tape around another decoration, or by using a string passed through another cavity which is formed by coiling the end portion several times so as to be perpendicular to the cavity at the center of the flower. In this manner the artificial flower can be used as a very beautiful decoration such as a necklace.

### BRIEF DESCRIPTION OF THE DRAWINGS

FIG. 1 is a plan view of a part of an embodiment of the present invention.

FIG. 2 is a perspective view of an embodiment of the present invention.

FIG. 3 is an illustrative view showing a method of making an embodiment of the present invention.

FIG. 4 is a view illustrating a method of making artificial flowers of the present invention.

### DETAILED DESCRIPTION OF THE PREFERRED EMBODIMENTS

The present invention will be practically described by Examples as follows. The present invention is not restricted to the Examples.

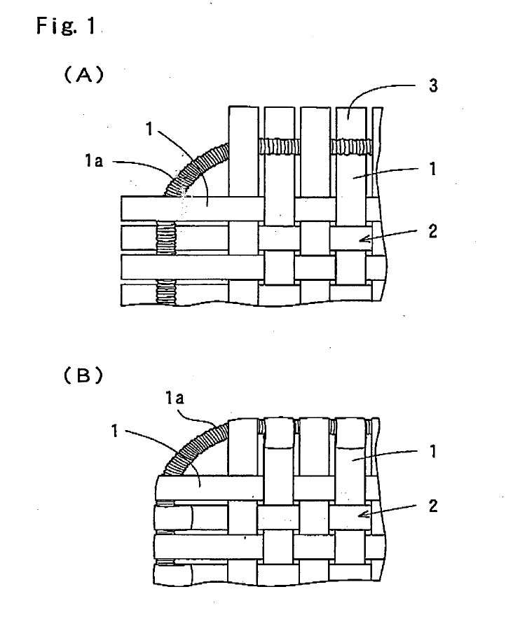

FIG. 1 shows a part of a dish-shaped decoration being formed by weaving tubular tapes 1 made of folded Japanese paper (printed paper). FIG. 1(A) shows a product just before it is finished and FIG. 1(B) shows the finished product.

In this embodiment, 10 mm-wide tapes and 7 mm-wide tapes are used. Some of them are partly twisted and gathered. Wires 0.7 mm in diameter are passed through all of the tubular tapes 1.

These tubular tapes 1 are woven by plain weaving to form a plate 2. At its peripheral portion, a gathered tape 1a is attached. Both end portions 3 of each tubular tape 1 protruding from the gathered tape 1a are bent alternately in opposite sides to cover said gathered tape 1a thereby to form an edge of the plate. A decoration with high decorative effect and high stability is then provided.

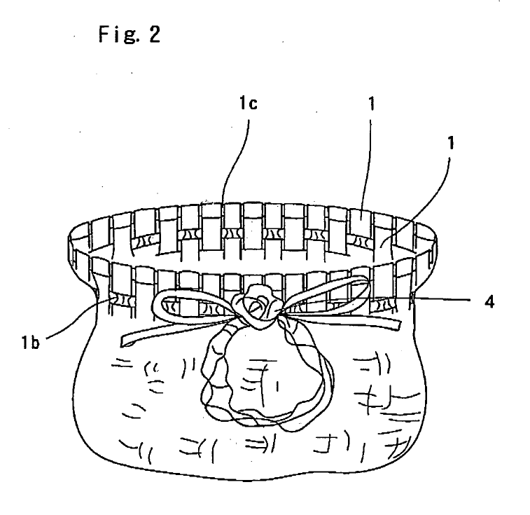

The embodiment of FIG. 2 shows a basket-shaped decoration prepared by the same method as in the embodiment of FIG. 1. First, 8 mm-wide tubular tapes 1 made of Japanese paper are woven at their middle portions by plain weaving to form a bottom of the decoration. Then both end portions of the tubular tapes 1 are bent upward. 5 mm-wide tubular tapes 1b are formed into rings and combined with both end portions of the tubular tapes 1 by plain weaving to form a side wall. The tubular tapes 1b are partly gathered or twisted to achieve a decorative effect and stability.

The periphery of the basket-shaped decoration is finished by bending both end portions of the tapes 1 protruding from the gathered tape 1c alternately in the opposite sides so as to cover the peripheral gathered tape 1c.

At the front of the basket-shaped decoration, decorations consisting of 5 mm-wide tubular tapes 1b are fitted.

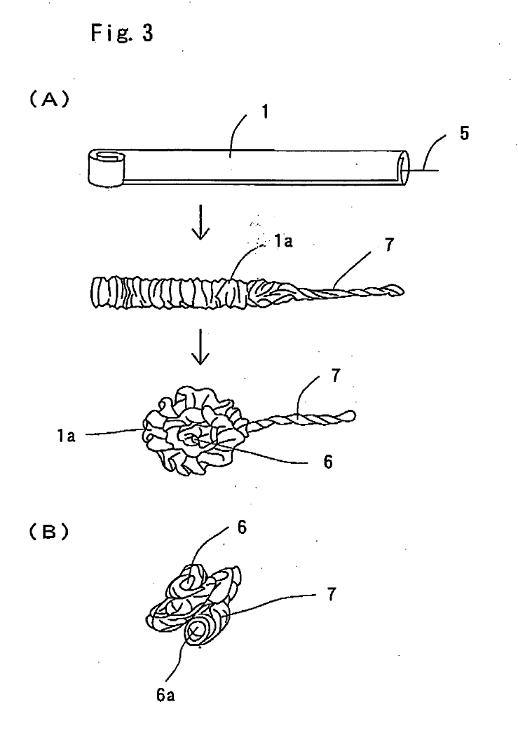

One of them is an artificial flower 4 formed by the method shown in FIG. 3 and the other is a ribbon-shaped decoration. Each decoration consists of a tubular tape including a wire and is fitted stably and well decoratively.

The products wholly comprise decorative Japanese paper and they are excellent in appearance. As wires are present in the whole body, they have an advantage that the form of the opening and other parts can be varied at will.

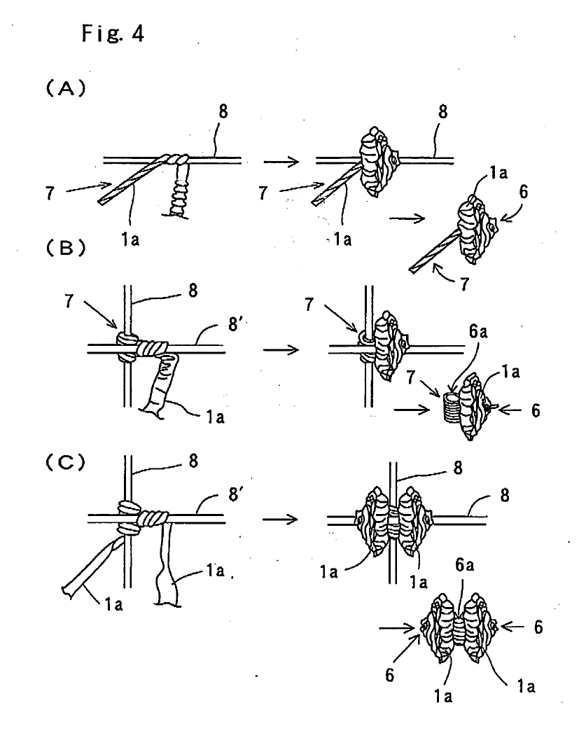

A method for making the artificial flower 4 is shown in FIG. 3. In this embodiment, a 8 mm-wide tubular tape 1 made of Japanese paper, through which a wire 5 is passed, is gathered to give a gathered tape 1a and it is wound around a bar 8 (bamboo spit) having a diameter of 2 mm and the bar 8 is pulled out to form a cavity 6 at a center of the flower 4. The wrinkles or gathers of the tape 1a represent beautiful petals. Several centimeters of the end portion 7 of the tape 1a are left unwound so as to be used as a clasp for another decoration (FIG. 4(A)). For example, it is easily fitted to the product of FIG. 1 or FIG. 2 at a proper place by binding the end portion 7 to the product.

In the artificial flower 4, the end portion 7 is coiled several times to form a cavity; 6a substantially perpendicular to said central cavity 6 as shown in FIG. 3(B) and the cavity 6a is used as a hole for passing a string. With the string, the artificial flower 4 can easily be used as a necklace and the like.

The product shown in FIG. 3(B) can be easily prepared by winding one end of the tape 1a around a first bar 8 several times, and placing a second bar 8′ to the first bar 8 perpendicularly to the wound portion, and winding the remainder of the tape 1a around the second bar 8′, and then pulling the two bars 8, 8′ out of the wound portions of the tape 1a (FIG. 4(B)).

Furthermore, a double-rose having a cavity 6a at the center for a string to be passed can be also formed by winding a middle portion of a tape 1a around a first bar 8 several times, and placing a second bar 8′ perpendicularly to said first bar 8, and winding both end portions of the tape 1a respectively around the second bar 8′ at the opposite sides of the first bar 8 to form two rose-shaped artificial flowers (Fig. (C)).

According to the present invention, with only tubular tapes, in each of which figured paper or cloth is used, it is easily possible to make a decorative product at a relatively low cost.

The surface of the product can be finished by coating with a transparent resin to achieve higher form stability, water resistance and antifouling property.

The present invention can easily provide decorative decorations by only tubular tapes through which a wire is passed. The product of the present invention is excellent in form stability by the presence of gathered tubular tapes and wires therein, and it is possible to change its shape at will.

1. A decoration made of tubular tapes through each of which a wire is passed in its whole length, wherein a plate is formed by weaving a plurality of said tubular tapes, with one of said tubular tapes being gathered and attached to the periphery of the plate, and both end portions of each said tubular tape protruding from the gathered tape are bent alternately in opposite sides to cover said gathered tape thereby to form an edge of the plate.

2. A decoration made of a tubular tape through which a wire is passed in its whole length, wherein said tubular tape is gathered and wound around a bar thinner than said tape and then the bar is pulled out to form a rose-shaped artificial flower having a cavity at its center with one end portion of said tape being used as a clasp.

3. The decoration according to claim 2, wherein one end portion of said tubular tape is coiled several times to form a second cavity perpendicular to said central cavity for a string to be passed through to be used as a clasp.

4. The decoration according to claim 1, wherein the tubular tapes are made of figured paper or cloth.

5. The decoration according to claim 2, wherein the tubular tape is made of figured paper or cloth.

6. The decoration according to claim 3, wherein the tubular tape is made of figured paper or cloth.
